(19) United States
(12) Patent Application Publication
(10) Pub. No.: US 2019/0377106 A1
(43) Pub. Date: Dec. 12, 2019

(54) LIGHT DIFFUSION COMPOSITION AND ARTICLES MADE THEREFROM

(71) Applicant: Eastman Chemical Company, Kingsport, TN (US)

(72) Inventors: Mark Allen Peters, Kingsport, TN (US); I. David Cross, Kingsport, TN (US)

(73) Assignee: Eastman Chemical Company, Kingsport, TN (US)

(21) Appl. No.: 16/549,569

(22) Filed: Aug. 23, 2019

Related U.S. Application Data
(63) Continuation of application No. 14/965,963, filed on Dec. 11, 2015, now abandoned.
(60) Provisional application No. 62/093,519, filed on Dec. 18, 2014.

(51) Int. Cl. G02B 5/02

(52) U.S. Cl. CPC G02B 5/0242; G02B 5/0268

(57) ABSTRACT

The invention relates to a light diffusion copolyester composition comprising a copolyester and a light diffusion additive. The invention further relates to articles made from the light diffusion copolyester composition comprising a copolyester and a light diffusion additive, articles made therefrom and processes for making the compositions and articles.

### CROSS-REFERENCE TO RELATED APPLICATION

This application is a continuation from U.S. application Ser. No. 14/965,963 filed Dec. 11, 2015, now U.S. Publication Number 2016-0178814; which claims priority to U.S. Provisional Application No. 62/093,519 filed Dec. 18, 2014, the disclosures of which are incorporated herein by reference in their entirety.

### BACKGROUND OF THE INVENTION

The lighting market provides articles that illuminate residential and commercial settings. This market is currently transitioning to more efficient light emitting diode (LED) lighting technology to reduce energy consumption and provide a long lifetime product. However, the new LED light sources emit light from high intensity point sources. These point sources must be diffused to provide illumination that is comfortable and efficient while not sacrificing high light transmission. High light transmission is important to maintain the energy efficiency of the overall lighting system.

It is well known in the industry that one way to create a light diffusing plastic compound is by the addition of light diffusing particles. These particles can be made from a variety of materials including acrylics, silica, silicone, polytetrafluoroethylene (PTFE) materials and glass. These particles can be made from a single polymer or copolymer or can often be made with a core-shell structure where an outer layer is composed of one polymer that encapsulates a polymer with a different composition. These particles range in size from 0.1 to 100 microns and are added in the range of 0.1 to 30 weight percent based on the total weight of polymer. In general, compounds with higher concentrations of particles have improved diffusion but reduced light transmission.

A variety of materials can be used as the base resin. The most common materials in the lighting industry are acrylic (polymethyl methacrylate, PMMA) and polycarbonate (PC). PMMA is inherently light stable and generally has excellent optical properties, but does not have very high impact strength and durability. PC is more susceptible to UV degradation than PMMA, but does have excellent optical properties and is more durable and impact resistant than PMMA. Copolyesters are often used in the same markets as PMMA and PC. Copolyesters are sensitive to UV degradation, but have excellent optical properties and high impact strength. Also, copolyesters are generally easier to process than PC due to the lower melt temperatures. Both PC and copolyesters are more durable and easier to fabricate than PMMA.

In order to create a durable, easy to process diffuser for LED luminaires, light diffusing particles are added to copolyesters. It was found that some particles reduce the impact strength when compounded with copolyesters or reduce the impact strength during reprocessing. Other particle compositions maintain the impact strength in the final compounds but the optical properties of diffusion and light transmission are not sufficient for the lighting market.

U.S. Patent Publication Number US2006/0100322A1 describes a resin composition comprising a polyester-based resin, a bead-type light diffusion resin comprising polymethyl methacrylate as a light diffuser, an antistatic agent, and an optical brightener. The specification also describes the optical properties of the composition in terms of haze and light transmission.

U.S. Patent Publication Numbers US2013/0266797A1 and US2013/0230733A1 describe the processes for making porous and filled acrylic beads for light diffusing compositions.

It is well known to those skilled in the art that light diffusing particles can be added to a polymer resin to diffuse LED light. These particles can be made from acrylic and are commonly crosslinked, but the particles can also be thermoplastic. The compatibility of the particle with the matrix material is important to maintain the impact strength of the final part. For example, formulations that use light diffusing particles made with silica diffuse LED light, but these particles reduce the impact strength of parts made with this formulation. Formulations that contain acrylic or silicone particles can be used to mold parts with high impact strength. However, these light diffusing compositions often fail to provide a combination of maximum light transmission, sufficient light diffusion, retained impact strength and retained impact strength is multiple passes through an extrusion process.

It is also well known to those skilled in the art that inorganic particles can be added to a light diffusion composition. These inorganic particles can be composed of TiO2, barium sulfate, calcium carbonate, etc. However, the use of these particles has a significant effect on the light transmission of the finished article with very little improvement in diffusion as well as a significant reduction in mechanical properties.

There is a need for a light diffusion composition comprising copolyesters and light diffusing particles providing a combination of maximized light transmission and light diffusion while maintaining the polymer article's impact strength. There is a need for a light diffusing copolyester composition that is also durable enough to survive multiple passes through an extrusion process without reducing impact strength or causing yellowness while maintaining optical properties of diffusion and light transmission.

### BRIEF SUMMARY OF THE INVENTION

One embodiment of the present invention concerns composition comprising:

a) 99 to 99.5 weight percent copolyester, and

b) 0.5 to 10 weight percent of an acrylic light diffusion additive having an D₅₀ average particle size ranging from less than 10 microns to about 2 microns,

wherein the composition has a light diffusion angle of from greater than 150 to about 170 degrees,

wherein the composition has a light transmission ranging from about 75 to about 95%, and a haze greater than 30%, measured according to ASTM D1003 on a plaque with a thickness of 3.175 mm (0.125 inch) and

wherein the weight percents are based on the total weight of the copolyester.

One embodiment of the present invention concerns an article comprising:

a copolyester composition comprising:

a) 90 to 99.5 weight percent copolyester, and

b) 0.5 to 10 weight percent of an acrylic light diffusion additive having an D₅₀ average particle size ranging from less than 10 microns to about 2 microns,

wherein the article has a light diffusion angle of from greater than 150 to about 170 degrees,

wherein the composition has a light transmission ranging from about 75 to about 95%, and a haze greater than 30%, measured according to ASTM D1003 on a plaque with a thickness of 3.175 mm (0.125 inch) and

wherein the weight percents are based on the total weight of the copolyester.

One embodiment of the present invention concerns a light diffusion composition comprising:

a) 90 to 99.5 weight percent copolyester, and

b) 0.5 to 10 weight percent of an acrylic light diffusion additive having an D₅₀ average particle size ranging from less than 10 microns to about 2 microns,

wherein the composition has a light diffusion angle of from greater than 150 to about 170 degrees,

wherein the composition has a light transmission ranging from about 75 to about 95%, and a haze greater than 30%, measured according to ASTM D1003 on a plaque with a thickness of 3.175 mm (0.125 inch),

wherein the weight percents are based on the total weight of the copolyester, and wherein the composition has an energy at maximum load greater than 30 Joules, after three passes through an extruder, measured on a plaque with a thickness of 3.175 mm (0.125 inch) according to ASTM D3763.

One embodiment of the present invention concerns an article comprising:

a copolyester composition comprising:

a) 90 to 99.5 weight percent copolyester, and

b) 0.5 to 10 weight percent of an acrylic light diffusion additive having an D₅₀ average particle size ranging from less than 10 microns to about 2 microns,

wherein the composition has a light diffusion angle of from greater than 150 to about 170 degrees,

wherein the composition has a light transmission ranging from about 75 to about 95%, and a haze greater than 30%, measured according to ASTM D1003 on a plaque with a thickness of 3.175 mm (0.125 inch),

wherein the weight percents are based on the total weight of the copolyester, and wherein the article has an energy at maximum load greater than 30 Joules, after three passes through an extruder, measured on a plaque with a thickness of 3.175 mm (0.125 inch) according to ASTM D3763.

One embodiment of the present invention concerns a light diffusion copolyester composition wherein the composition has an energy at maximum load of at least 30 Joules at both 23° C. and −23° C. with no measured brittleness, measured according to ASTM D3763, after three passes through an extruder.

One embodiment of the present invention concerns a light diffusion article comprising a copolyester composition wherein the composition has an energy at maximum load of at least 30 Joules at both 23° C. and −23° C., measured according to ASTM D3763, after three passes through an extruder.

### BRIEF DESCRIPTION OF THE DRAWINGS

FIG. 1 shows a graph of diffusion and light transmission versus diffusion additive particle size.

FIG. 2 shows a graph of diffusion and light transmission versus diffusion additive concentration.

FIG. 3 shows a graph of percent light transmission and percent diffusion versus diffusion additive concentration.

FIG. 4 shows a graph of energy at max load at 23° C. versus the number of extruder passes for an acrylic (Kolon™ MH-5FHD) diffusion additive.

FIG. 5 shows a graph of energy at max load at −20° C. versus the number of extruder passes for Ampacet™ 7000013-NP LIGHT DIFFUSER PET MB diffusion additive.

### DETAILED DESCRIPTION

The present invention may be understood more readily by reference to the following detailed description of certain embodiments of the invention and the working examples.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C1 to C5 hydrocarbons,” is intended to specifically include and disclose C1 and C5 hydrocarbons as well as C2, C3, and C4 hydrocarbons.

Notwithstanding that the numerical ranges and parameters setting forth the broad scope of the invention arc approximations, the numerical values set forth in the specific examples are reported as precisely as possible. Any numerical value, however, inherently contains certain errors necessarily resulting from the standard deviation found in their respective testing measurements.

As used in the specification and the claims, the singular forms “a,” “an” and “the” include their plural references unless the context clearly dictates otherwise. For example, reference to a “promoter” or a “reactor” is intended to include the one or more promoters or reactors. References to a composition or process containing or including “an” ingredient or “a” step is intended to include other ingredients or other steps, respectively, in addition to the one named.

The terms “containing” or “including,” are synonymous with the term “comprising,” and is intended to mean that at least the named compound, element, particle, or method step, etc., is present in the composition or article or method, but does not exclude the presence of other compounds, catalysts, materials, particles, method steps, etc., even if the other such compounds, material, particles, method steps, etc., have the same function as what is named, unless expressly excluded in the claims.

It is also to be understood that the mention of one or more method steps does not preclude the presence of additional method steps before or after the combined recited steps or intervening method steps between those steps expressly identified. Moreover, the lettering of process steps or ingredients is a convenient means for identifying discrete activities or ingredients and the recited lettering can be arranged in any sequence, unless otherwise indicated.

Copolyesters useful in the present invention comprise residues of an aromatic diacid and residues of two or more glycols; or residues of two or more aromatic diacid and residues of two or more glycols. The copolyester can be made from any of the traditional compositions described as polyethylene terephthalate (PET), glycol modified PET (PETG), glycol modified poly(cyclohexylene dimethylene terephthalate) (PCTG), poly(cyclohexylene dimethylene terephthalate) (PCT), acid modified poly(cyclohexylene dimethylene terephthalate) (PCTA), and any of the forgoing polymers modified with 2,2,4,4-tetramethylcyclobutane-1,3-diol.

The term “copolyester,” as used herein, is intended to include “polyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds. Typically the difunctional carboxylic acid can be a dicarboxylic acid and the difunctional hydroxyl compound can be a dihydric alcohol such as, for example, glycols. Furthermore, as used in this application, the interchangeable terms “diacid” or “dicarboxylic acid” include multifunctional acids, such as branching agents. The term “glycol” as used in this application includes, but is not limited to, diols, glycols, and/or multifunctional hydroxyl compounds. Alternatively, the difunctional carboxylic acid may be a hydroxy carboxylic acid such as, for example, p-hydroxybenzoic acid, and the difunctional hydroxyl compound may be an aromatic nucleus bearing 2 hydroxyl substituents such as, for example, hydroquinone. The term “residue,” as used herein, means any organic structure incorporated into a polymer through a polycondensation and/or an esterification reaction from the corresponding monomer. The term “repeating unit,” as used herein, means an organic structure having a dicarboxylic acid residue and a diol residue bonded through a carbonyloxy group. Thus, for example, the dicarboxylic acid residues may be derived from a dicarboxylic acid monomer or its associated acid halides, esters, salts, anhydrides, or mixtures thereof. As used herein, therefore, the term dicarboxylic acid is intended to include dicarboxylic acids and any derivative of a dicarboxylic acid, including its associated acid halides, esters, half-esters, salts, half-salts, anhydrides, mixed anhydrides, or mixtures thereof, useful in a reaction process with a diol to make polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, or mixtures thereof or residues thereof useful in a reaction process with a diol to make polyester. The term “modifying aromatic diacid” means an aromatic dicarboxylic acid other the terephthalic acid. The term “modifying glycol” means a glycol other than 1,4-cyclohexane dimethanol.

In one embodiment, terephthalic acid may be used as the starting material. In another embodiment, dimethyl terephthalate may be used as the starting material. In another embodiment, mixtures of terephthalic acid and dimethyl terephthalate may be used as the starting material and/or as an intermediate material.

The copolyesters used in the present invention typically can be prepared from dicarboxylic acids and diols which react in substantially equal proportions and are incorporated into the copolyester polymer as their corresponding residues. The copolyesters of the present invention, therefore, can contain substantially equal molar proportions of acid residues (100 mole %) and diol (and/or multifunctional hydroxyl compounds) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a copolyester containing 30 mole % isophthalic acids, based on the total acid residues, means the copolyester contains 30 mole % isophthalic acid residues out of a total of 100 mole % acid residues. Thus, there are 30 moles of isophthalic acid residues among every 100 moles of acid residues. In another example, a copolyester containing 30 mole % 1,4-cyclohexanedimethanol, based on the total diol residues, means the copolyester contains 30 mole % 1,4-cyclohexanedimethanol residues out of a total of 100 mole % diol residues. Thus, there are 30 moles of 1,4-cyclohexanedimethanol residues among every 100 moles of diol residues.

The copolyesters comprise 70 to 100 mole % of an aromatic diacid. In one embodiment, the copolyesters comprise 70 to 100 mole % of terephthalic acid (TPA). Alternatively, the copolyesters comprise 80 to 100 mole % TPA, or 90 to 100 mole % TPA or 95 to 100 mole % TPA or 100 mole TPA. For the purposes of this disclosure, the terms “terephthalic acid” and “dimethyl terephthalate” are used interchangeably herein.

In addition to terephthalic acid, the dicarboxylic acid component of the copolyester useful in the invention can comprise up to 30 mole %, up to 20 mole %, up to 10 mole %, up to 5 mole %, or up to 1 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, from 0.01 to 30 mole %, 0.01 to 20 mole %, from 0.01 to 10 mole %, from 0.01 to 5 mole % and from 0.01 to 1 mole. In one embodiment, modifying aromatic dicarboxylic acids that may be used in the present invention include but are not limited to those having up to 20 carbon atoms, and which can be linear, para-oriented, or symmetrical. Examples of modifying aromatic dicarboxylic acids which may be used in this invention include, but are not limited to, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid.

The carboxylic acid component of the copolyesters useful in the invention can be further modified with up to 10 mole %, such as up to 5 mole % or up to 1 mole % of one or more aliphatic dicarboxylic acids containing 2-16 carbon atoms, such as, for example, malonic, succinic, glutaric, adipic, pimelic, suberic, azelaic and dodecanedioic dicarboxylic acids. Certain embodiments can also comprise 0.01 or more mole %, such as 0.1 or more mole %, 1 or more mole %, 5 or more mole %, or 10 or more mole % of one or more modifying aliphatic dicarboxylic acids. Yet another embodiment contains 0 mole % modifying aliphatic dicarboxylic acids. Thus, if present, it is contemplated that the amount of one or more modifying aliphatic dicarboxylic acids can range from any of these preceding endpoint values including, for example, from 0.01 to 10 mole % and from 0.1 to 10 mole %. The total mole % of the dicarboxylic acid component is 100 mole %.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

The copolyesters useful in the copolyesters compositions of the invention can comprise from 0 to 10 mole percent, for example, from 0.01 to 5 mole percent, from 0.01 to 1 mole percent, from 0.05 to 5 mole percent, from 0.05 to 1 mole percent, or from 0.1 to 0.7 mole percent, based the total mole percentages of either the diol or diacid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the polyester. The copolyester(s) useful in the invention can thus be linear or branched.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole percent of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester in the form of a concentrate as described, for example, in U.S. Pat. Nos. 5,654,347 and 5,696,176, whose disclosure regarding branching monomers is incorporated herein by reference.

All of the following embodiments of copolyesters are useful in all of the embodiments of the present invention. In certain embodiments the glycol component of the copolyester comprises ethylene glycol and 1,4-cyclohexanedimethanol. In one embodiment the glycol component of the copolyester comprises 1 to 65 mole % 1,4-cyclohexanedimethanol and 35 to 99 mole % ethylene glycol. In one embodiment the glycol component of the copolyester comprises 1 to 50 mole % 1,4-cyclohexanedimethanol and 50 to 99 mole % ethylene glycol. In one embodiment the glycol component of the copolyester comprises about 1 to 31 mole % 1,4-cyclohexanedimethanol and about 69 to 99 mole % ethylene glycol. In one embodiment the glycol component of the copolyester comprises about 31 mole % 1,4-cyclohexanedimethanol and about 69 mole % ethylene glycol. In one embodiment the glycol component of the copolyester comprises about 5 to 65 mole % 1,4-cyclohexanedimethanol and about 35 to 95 mole % ethylene glycol. In one embodiment the glycol component of the copolyester comprises about 5 to 50 mole % 1,4-cyclohexanedimethanol and about 50 to 95 mole % ethylene glycol. In one embodiment the glycol component of the copolyester comprises about 10 to 65 mole % 1,4-cyclohexanedimethanol and about 35 to 90 mole % ethylene glycol. In one embodiment the glycol component of the copolyester comprises about 10 to 50 mole % 1,4-cyclohexanedimethanol and about 50 to 90 mole % ethylene glycol. In one embodiment the glycol component of the copolyester comprises about 20 to 65 mole % 1,4-cyclohexanedimethanol and about 35 to 80 mole % ethylene glycol. In one embodiment the glycol component of the copolyester comprises about 20 to 50 mole % 1,4-cyclohexanedimethanol and about 50 to 80 mole % ethylene glycol. In one embodiment the glycol component of the copolyester comprises about 30 to 65 mole % 1,4-cyclohexanedimethanol and about 35 to 70 mole % ethylene glycol. In one embodiment the glycol component of the copolyester comprises about 30 to 50 mole % 1,4-cyclohexanedimethanol and about 50 to 70 mole % ethylene glycol.

The 1,4-cyclohexanedimethanol may be cis, trans, or a mixture thereof, for example a cis/trans ratio of 60:40 to 40:60. In another embodiment, the trans-1,4-cyclohexanedimethanol can be present in an amount of 60 to 80 mole %. Alternatively, 1,2- and/or 1-3-cyclohexanedimethanol may be used individually or in combination with each other and/or 1,4-cyclohexanedimethanol.

In certain embodiments of the present invention, the thermoplastic resins have inherent viscosity (I.V.) values in the range of 0.5 dL/g to 1.2 dL/g or from 0.6 dL/g to 1.2 dL/g or from 0.7 dL/g to 1.2 dL/g or from 0.8 dL/g to 1.2 dL/g or from 0.5 dL/g to 1.1 dL/g or from 0.6 dL/g to 1.1 dL/g or from 0.7 dL/g to 1.1 dL/g or from 0.8 dL/g to 1.1 dL/g or from 0.5 dL/g to 1.0 dL/g or from 0.6 dL/g to 1.0 dL/g or from 0.7 dL/g to 1.0 dL/g or from 0.8 dL/g to 1.0 dL/g, as measured at 25° C. in 60/40 wt/wt phenol/tetrachloroethane.

In certain embodiments of the present invention, the thermoplastic resins have a glass transition temperature ranging from 75 to 95° C.; or from 70 to 90° C.; or from 70 to 85° C.; or from 75 to 90° C.; or from 75 to 85° C.

In one aspect the polymers useful in the present invention have crystallization half-times greater than 3 minutes, or greater than 5 minutes or greater than 12 minutes or greater than 15 minutes. In one aspect the polyesters useful in the present invention have crystallization half-times greater than 3 minutes, or greater than 5 minutes or greater than 12 minutes or greater than 15 minutes.

The crystallization half-time of the polyester, as used herein, may be measured using methods well-known to persons of skill in the art. For example, the crystallization half-time may be measured using a Perkin-Elmer Model DSC-2 differential scanning calorimeter. The crystallization half-time is measured from the molten state using the following procedure: a 15.0 mg sample of the polyester is sealed in an aluminum pan and heated to 290° C. at a rate of about 320° C./min for 2 minutes. The sample is then cooled immediately to the predetermined isothermal crystallization temperature at a rate of about 320° C./minute in the presence of helium. The isothermal crystallization temperature is the temperature between the glass transition temperature and the melting temperature that gives the highest rate of crystallization. The isothermal crystallization temperature is described, for example, in Elias, H. Macromolecules, Plenum Press: NY, 1977, p 391. The crystallization half-time is determined as the time span from reaching the isothermal crystallization temperature to the point of a crystallization peak on the DSC curve.

The polyester portion of the copolyester compositions useful in the invention can be made by processes known from the literature such as, for example, by processes in homogenous solution, by transesterification processes in the melt, and by two phase interfacial processes. Suitable methods include, but are not limited to, the steps of reacting one or more dicarboxylic acids with one or more glycols at a temperature of 100° C. to 315° C. at a pressure of 0.1 to 760 mm Hg for a time sufficient to form a copolyester. See U.S. Pat. No. 3,772,405 for methods of producing copolyesters, the disclosure regarding such methods is hereby incorporated herein by reference.

In another aspect, the invention relates to articles comprising a copolyester produced by a process comprising:

(I) heating a mixture comprising the monomers useful in any of the copolyesters in the invention in the presence of a catalyst at a temperature of 150 to 240° C. for a time sufficient to produce an initial copolyester;

(II) heating the initial copolyester of step (I) at a temperature of 240 to 320° C. for 1 to 4 hours; and

(III) removing any unreacted glycols.

Suitable catalysts for use in this process include, but are not limited to, organo-zinc or tin compounds. The use of this type of catalyst is well known in the art. Examples of catalysts useful in the present invention include, but are not limited to, zinc acetate, butyltin tris-2-ethylhexanoate, dibutyltin diacetate, and dibutyltin oxide. Other catalysts may include, but are not limited to, those based on titanium, zinc, manganese, lithium, germanium, and cobalt. Catalyst amounts can range from 10 ppm to 20,000 ppm or 10 to 10,000 ppm, or 10 to 5000 ppm or 10 to 1000 ppm or 10 to 500 ppm, or 10 to 300 ppm or 10 to 250 based on the catalyst metal and based on the weight of the final polymer. The process can be carried out in either a batch or continuous process.

Typically, step (I) can be carried out until 50% by weight or more of the glycol has been reacted. Step (I) may be carried out under pressure, ranging from atmospheric pressure to 100 psig. The term “reaction product” as used in connection with any of the catalysts useful in the invention refers to any product of a polycondensation or esterification reaction with the catalyst and any of the monomers used in making the polyester as well as the product of a polycondensation or esterification reaction between the catalyst and any other type of additive.

Typically, Step (II) and Step (III) can be conducted at the same time. These steps can be carried out by methods known in the art such as by placing the reaction mixture under a pressure ranging from 0.002 psig to below atmospheric pressure, or by blowing hot nitrogen gas over the mixture.

The light diffusing copolyesters are useful, for example, with light emitting diodes (LEDs) used in panels for lights and for flat panel displays. One embodiment of the present invention concerns an article comprising a copolyester compositions comprising a) 99.2 to 99.8 weight percent copolyester, and b) 0.5 to 0.8 weight percent of an acrylic light diffusion additive having an D₅₀ average particle size ranging from less than 10 microns to about 2 microns, wherein the article has a light diffusion angle of from greater than 150 to about 170 degrees, wherein the composition has a light transmission ranging from about 75 to about 95%, and a haze greater than 30%, measured according to ASTM D1003 on a plaque with a thickness of 3.175 mm (0.125 inch) and wherein the weight percents are based on the total weight of the copolyester.

The articles typically have a thickness ranging from 0.0254 mm to 12.7 mm or from 0.127 mm to 6.35 mm or from 0.254 mm to 3.175 mm. The articles typically have a length ranging from 1 mm to 3048 mm or from 5 mm to 2438 mm or from 10 mm to 1219 mm. The articles typically have a width ranging from 1 mm to 3048 mm or from 5 mm to 2438 mm or from 10 mm to 1219 mm.

The polyester compositions are useful in articles of manufacture including, but not limited to, extruded, calendered, and/or molded articles including, but not limited to, injection molded articles, extruded articles, cast extrusion articles, profile extrusion articles, melt spun articles, thermoformed articles, extrusion molded articles, injection blow molded articles, injection stretch blow molded articles, extrusion blow molded articles and extrusion stretch blow molded articles. These articles can include, but are not limited to, films, bottles, containers, sheet and/or fibers.

The polyester compositions useful in the invention may be used in various types of film and/or sheet, including but not limited to extruded film(s) and/or sheet(s), calendered film(s) and/or sheet(s), compression molded film(s) and/or sheet(s), solution casted film(s) and/or sheet(s). Methods of making film and/or sheet include but are not limited to extrusion, calendering, compression molding, and solution casting. The extruded sheet can be further modified using typical fabrication techniques such as thermoforming, cold bending, hot bending, adhesive bonding, cutting, drilling, laser cutting, etc. to create a shapes useful for application as light diffusers.

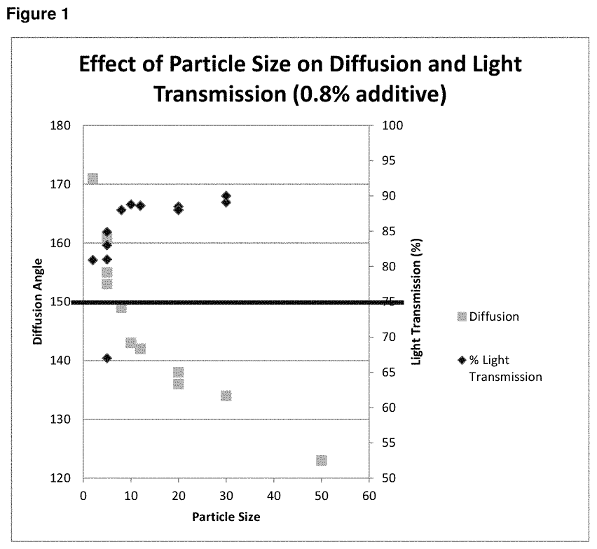

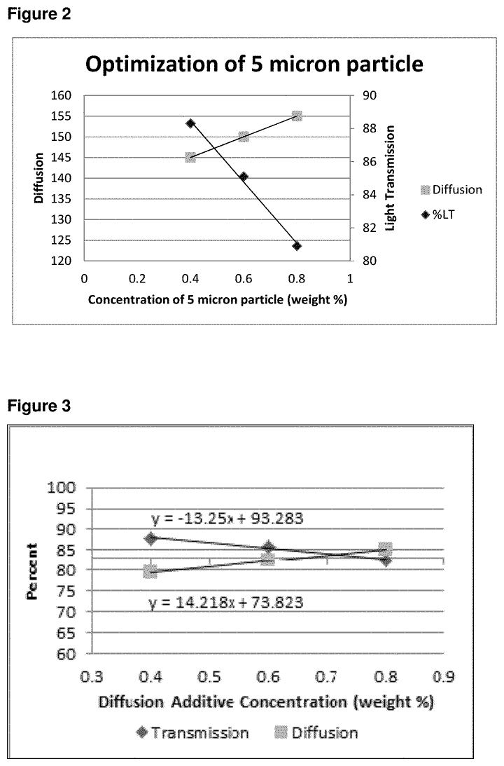

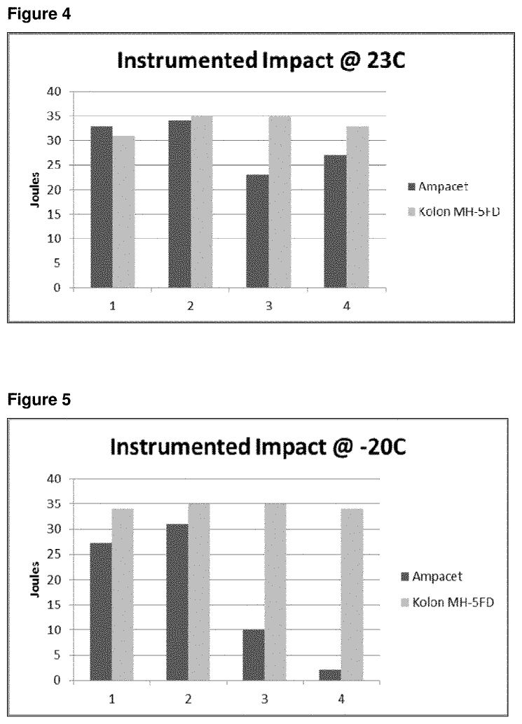

It was surprisingly found that the size of the particle was also important in determining the performance of the final part. Light transmission increases rapidly as the particle size increases and reaches a maximum value around 10 microns, regardless of the composition of the particle (FIG. 1). It was also found that the diffusion decreases as the particle size increases. In fact, the testing shows that a particle size less than 10 microns is optimum to maximize both light transmission (as high as possible) and light diffusion defined as a diffusion angle greater than 150 degrees. As particle size decreases, lower concentrations of particles are required to achieve optimum performance which reduces the cost of the formulation. For example, the part made with a formulation containing a 5 micron particle diffuses light more efficiently than the formulation containing the 10 micron particle. The efficiency of the smaller particle provides the ability to reduce the concentration of the 5 micron particle by as much as 25% and still achieve the same performance (FIG. 2). Assuming both particles are similar in price, this efficiency would reduce the cost of the overall system.

The weight percent of the light diffusion additives may range from 0.2 to 20 weight percent; or from 0.4 to 20 weight percent; or from 0.5 to 20 weight percent; or from 0.8. to 20 weight percent; or from 0.2 to 10 weight percent; or from 0.4 to 10 weight percent; or from 0.5 to 10 weight percent; or from 0.8. to 10 weight percent; or from 0.2 to 2.0 weight percent; or from 0.4 to 2.0 weight percent; or from 0.5 to 2.0 weight percent; or from 0.8. to 2.0 weight percent; or from 0.2 to 1.2 weight percent; or from 0.4 to 1.2 weight percent; or from 0.5 to 1.2 weight percent; or from 0.8. to 1.2 weight percent.

The light diffusing particles typically have compositions comprising acrylic resins which impart good light diffusion while retaining impact strength. One preferred acrylic light diffusing polymer is Kolon™ MH-5FHD. Other useful acrylic light diffusing particles include Dow Paraloid™ EXL-5137, having a butadiene/styrene core with a methyl methacrylate (MMA) shell and acrylic particles made by Sekisui Plastics.

The acrylic light diffusing additive typically has a D₅₀ average particle size less than 10 microns, or 0.5 to less than 10 microns, or 2 to 8 microns, or 2 to 10 microns, or 5 to 10 microns, or 2 to 5 microns or 4 to 6 microns. Unexpectedly, the light diffusing additives with a D₅₀ average particle size less than 10 microns provides a combination of sufficient light transmission at a haze greater than 30%, as measured according to ASTM D₁₀₀₃, while providing a light diffusion angle greater than 150 degrees. Additionally, the smaller D₅₀ average particle size permits the use of lower quantities of the light diffusing particles which improves the impact properties of the articles.

Table 1 shows particle size trials including light transmission and diffusion angle test results. At a diffusion angle greater than or equal to 150 degrees the LED is completely hidden from view.

TABLE 1
Particle Size Trials Using Cross-linked Acrylic Microbeads

| | Particle | | | % Light | |
|---|---|---|---|---|---|
| | Size | | MICROBEAD | Transmission | diffusion |
| MICROBEAD | (microns) | | (Wt %) | (Hazegard) | angle |
| Techpolymer ™ | 51.19 | Copolymer of methyl methacrylate | 0.4 | 89.6 | 115 |
| MBX-50 | | and ethylene glycol dimethacrylate | 0.6 | 89.3 | 120 |
| | | Cross-linked, solid bead. | 0.8 | 89.1 | 123 |
| Techpolymer ™ | 27.29 | Copolymer of methyl methacrylate | 0.4 | 89.2 | 124 |
| MBX-30 | | and ethylene glycol dimethacrylate | 0.6 | 88.9 | 130 |
| | | Cross-linked, solid bead. | 0.8 | 88.5 | 134 |
| KOLON ™ | 19.5 | Crosslinked PMMA | 0.4 | 89.2 | 127 |
| MH-20FD | | | 0.6 | 89.3 | 132 |
| | | | 0.8 | 88.4 | 136 |
| Techpolymer ™ | 17.6 | Copolymer of methyl methacrylate | 0.4 | 89.2 | 128 |
| MBX-20 | | and ethylene glycol dimethacrylate | 0.6 | 88.4 | 132 |
| | | Cross-linked, solid bead. | 0.8 | 88.6 | 138 |
| Techpolymer ™ | 11.81 | Copolymer of methyl methacrylate | 0.4 | 89.3 | 134 |
| MBX-12 | | and ethylene glycol dimethacrylate | 0.6 | 89.1 | 140 |
| | | Cross-linked, solid bead. | 0.8 | 88.8 | 142 |
| KOLON ™ | 10.1 | Crosslinked PMMA | 0.4 | 88.9 | 137 |
| MH-10FD | | | 0.6 | 88.6 | 141 |
| | | | 0.8 | 88.1 | 143 |
| Techpolymer ™ | 7.05 | Copolymer of methyl methacrylate | 0.4 | 89.1 | 142 |
| MBX-8 | | and ethylene glycol dimethacrylate | 0.6 | 87.7 | 145 |
| | | Cross-linked, solid bead. | 0.8 | 84.9 | 149 |
| SEKISUI | 6.91 | Crosslinked Acrylic Resin, | 0.4 | 87.8 | 143 |
| ARP-8 | | Copolymer of Alkyl acrylate & | 0.6 | 86.1 | 147 |
| | | ethyleneglycol dimethacrylate. | 0.8 | 83.2 | 151 |
| | | Porous bead. | | | |
| KOLON ™ | 5.3 | Crosslinked PMMA | 0.4 | 87.8 | 143 |
| MH-5FD | | | 0.6 | 85.7 | 148 |
| | | | 0.8 | 82.5 | 153 |
| Techpolymer ™ | 4.86 | Copolymer of methyl methacrylate | 0.4 | 88.3 | 145 |
| MBX-5 | | and ethylene glycol dimethacrylate | 0.6 | 85.1 | 150 |
| | | Cross-linked, solid bead. | 0.8 | 80.9 | 155 |
| Techpolymer ™ | 2.71 | Copolymer of methyl methacrylate | 0.4 | 87.7 | 145 |
| MBX-2H | | and ethylene glycol dimethacrylate | 0.6 | 82.5 | 152 |
| | | Cross-linked, solid bead. | 0.8 | 76.9 | 158 |

The minimum diffusion angle (Table 1) required to completely hide the LED is 150 degrees for a diffuser placed 1 inch away from an LED source that is placed 1 inch away from its neighboring LED source. Two out of thirty-three trials resulted in a diffusion angle greater than or equal to 150 degrees at a microbead concentration <0.8 wt %, specifically at 0.6 wt %. A diffusion angle of 150 degrees diffusion was not achieved with any microbead at 0.4 wt % concentration in Table 1 for a plaque with thickness of 0.125 inches. However, microbeads at 0.4 wt % concentration can be suitable for sheet having thickness greater than 0.125 inches.

Table 2 shows the four microbeads which resulted in a diffusion angle greater than or equal to 150 degrees, listed in order from highest to lowest light transmission. Light transmission in Table 2 is the percent light transmission at 150 degrees of diffusion, predicted by a linear regression model derived from the data obtained at 0.4, 0.6, and 0.8 wt % microbead concentrations. The last column shows the linear correlation coefficient for each model. The high correlation coefficients indicate that light transmission decreased at a relatively linear rate as additive level increased from 0.4-0.8 wt %.

Note that all four of the light transmission values agree within 1 unit (range=84.2%-85.2%). Also, there is no apparent correlation between light transmission and particle size. It should be emphasized that the light transmission values in Table 2 correspond to a single, minimum level of sufficient diffusion angle of 150 degrees.

TABLE 2
Additives with Diffusion Angle Greater
Than or Equal to 150 degrees

| | Particle | Light | Model |
|---|---|---|---|
| | Size | Transmission | Correlation |
| Microbead | (micron) | (%) | (R²) |
| Techpolymer ™ MBX-5 | 4.86 | 85.2 | 0.9939 |
| Kolon ™ MH-5FD | 5.3 | 84.7 | 0.9858 |
| Sekisui ARP-8 | 6.91 | 84.3 | 0.9778 |
| Techpolymer ™ MBX-2H | 2.71 | 84.2 | 0.9995 |

TABLE 3

| | | | Additive | Percent | | |
|---|---|---|---|---|---|---|
| | Particle | | Concen- | Light | | |
| | Size | | tration | Trans- | Diffusion | Percent |
| | (microns) | | (Wt %) | mission | Angle | Diffusion |
| KOLON | 5.3 | Cross- | 0.4 | 87.8 | 143 | 80 |
| MH-5FD | | linked | 0.6 | 85.7 | 148 | 82 |
| | | PMMA | 0.8 | 82.5 | 153 | 85 |

Diffusion in degrees has been converted to percent by the following equation: Percent Diffusion=(diffusion angle/180 degrees)×100%.

As microbead size decreases less of the light diffusion additive is required to achieve a diffusion angle of 150 degrees; the slope of light transmission becomes more negative at light diffusion additive amounts of 0.5 wt % and above; the slope of diffusion increases, with the exception of the 4.86 micron and 5.3 micron microbeads (see Table 3); a decrease in light transmission and an increase in diffusion occurs at light diffusion additive amounts of 0.5 wt % and above.

The minimum level of diffusion required to completely hide a single LED (83%, 150 degrees) is not always desirable in luminaire applications. For example: while 150 degrees diffusion may be sufficient in a luminaire design that incorporates an LED horizontal spacing distance of 1 inch, a design having an LED spacing distance of 2 inches may require a much higher diffusion angle to eliminate dark spots between the LEDs. Diffusion gain always results in light transmission loss. Since maximum light transmission is always desirable, the rate at which light transmission loss occurs, relative to diffusion gain, is a significant factor to consider. The preferred microbead is not simply one that results in the highest light transmission at the minimum level of diffusion, but one that results in the highest light transmission over a diffusion range.

Table 4 lists the slope values of light transmission and diffusion plots, based on the data in Table 3, sorted by the rate at which light transmission decreases relative to diffusion (“TSM”), determined by (Transmission Slope/Diffusion Slope). Since high diffusion and high transmission are equally important properties of a diffuser, larger (less negative) TSM values are desirable. For example: A TSM of −1.0 indicates that light transmission and diffusion change at the exact same rate, while a TSM value of −2.0 indicates that, for every unit increase of diffusion, light transmission is reduced by 2×.

TABLE 4
Slope Analysis

| | Measured Avg | Diffusion | Transmission | TSM |
|---|---|---|---|---|
| | Particle Size | Slope | Slope | (Transmission |
| Microbead | (micron) | (0.4-0.8 wt %) | (0.4-0.8 wt %) | Slope Multiplier) |
| Kolon ™ MH-5FD | 5.3 | 14.2 | −13.3 | −0.93x |
| Sekisui ARP-8 | 6.91 | 11.1 | −11.5 | −1.04x |
| Techpolymer ™ MBX-5 | 4.86 | 13.9 | −18.5 | −1.33x |
| Techpolymer ™ MBX-2H | 2.71 | 18.1 | −27.0 | −1.50x |

Table 4 shows that diffusion slope increases with decreasing particle size and that the transmission slope increases (becomes more negative) with decreasing particle size. The TSM of the Kolon™ MH-5FD microbead is significantly less negative than the Sekisui ARP-8, Techpolymer™ MBX-5 and Techpolymer™ MBX-2H microbeads. This indicates that higher light transmission was measured with the Kolon™ MH-5FD microbeads, over its entire diffusion range, in comparison to the Sekisui microbeads and their entire diffusion ranges.

That transmission slope is influenced by particle size is unexpected result as this led to the discovery that there is an optimum particle size for maximizing light transmission and diffusion simultaneously, particularly within the microbead concentration range of 0.4-0.8 wt %. The data shows the sharp increase in diffusion and decrease in transmission when the particle size drops below 10 microns. In general, transmission slope increases (becomes less negative) with decreasing particle size. A noticeable shift in the data set occurs between 10.1 microns and 7.05 microns.

The maximum diffusion and maximum transmission are equally important properties of a light diffuser to luminaire designers. The minimum level of diffusion that will sufficiently hide the LEDs in a given luminaire design is favorable because higher diffusion values result in lower transmission values. The most prevalent expectation for diffusers, by luminaire designers, is light transmission throughput greater than or equal to 80% as measured by ASTM D 1003. A minimum acceptable light transmission value of 80% can be achieved in 0.125 inch (3.175 mm) thick Spectar™ copolyester 144711 plaques with Techpolymer™ MBX-2H or Kolon™ MH-5FD, both having a diffusion angle of 155 degrees.

Recycling copolyesters by multiple passes through an extruder often causes the copolyester to degrade resulting in reduced impact strength. The light diffusing copolyester compositions of the present invention may be recycled through an extruder in order to process scrap copolyester or regrind. The light diffusing compositions of the present invention may be recycled through at least three passes through an extrusion while maintaining an instrumented impact strength reported as an energy at maximum load of at least about 30 Joules measured at both 23° C. and −20° C. In contrast, light diffusing copolyester composition using Ampacet™ particles failed to maintain an instrumented impact strength reported as an energy at maximum load of at least about 30 Joules measured at both 23° C. and −20° C.

### Method of Measuring Diffusion Angle

A sample plaque 4 inches (10.16 cm)×4 inches (10.16 cm)×0.125 inch (0.318 cm) is positioned exactly 1 inch (2.54 cm) above a single LED source having a beam angle of 105 degrees and a light output of 10 lumens. The LED is a dual source 12V Sloan LED, model 701269-WS-MB, 6500K with an output of 20 lumens, but one bulb was masked with black electrical tape to limit the output to 10 lumens.

A Sony DSC-H90 digital camera is positioned directly above the sample plaque so that the distance between the lens, extended to 10× magnification, and the top surface of the plaque is exactly 9 inches (22.86 cm) and is used to capture a digital image of the LED source as it is being diffuser through the diffuser plate.

TABLE 5
Image Capture Parameters

| | |
|---|---|
| Camera | Sony Cybershot, DSC-H90 |
| Lens | 34 mm focal length, rectilinear |
| Image Format | 4:3 VGA, 640 × 480 pixels, 3.20″ × 2.40″ |
| Magnification | 9.9X |
| ISO Speed | 200 |
| Aperture | 1/25^{th} seconds |
| F-Stop | 13 |
| Centering | View finder grid set to “On” for precise centering of |
| | image |
| Flash | Not used |
| Delay Time | 10 second delay used to ensure camera stability |

The digital image is converted to pixel brightness values using ImageJ software. ImageJ software is available for download from http://rsbweb.nih.gov/ij/.

Pixel brightness values and the width of the image are normalized to the same scale.

Pixel brightness values are used to calculate the angle formed by the apex (maximum pixel brightness) and the two pixel brightness values located exactly 0.5 inch (1.27 cm) to either side of the apex. Images taken with the camera settings described above were transferred in JPEG format, compressed 4 bits/pixel, 24 bit depth, 640×480 pixels, 350 dpi, with a resolution unit of 2. The outer top and outer bottom edges of the LED light halo are determined by visual inspection. A Gaussian-shaped plot of the pixel brightness values is derived from the area cross section framed by the outer edges of the LED light halo. The resultant angle is the diffusion angle, having a range of 105 degrees to 180 degrees.

### EXAMPLES

### General

Compounding procedure: A copolyester having 31 mole % 1,4-cyclohexane dimethanol, 69 mole % ethylene glycol and 100 mole % terephthalic acid (made by Eastman Chemical Company) was dried and pre-blended with the additive particle. The blend was then compounded on either a Sterling 1.25 inch (3.18 cm) single screw extruder or a Warner and Pfleider 30 mm twin screw extruder to create an additive concentrate. The concentrate was then mixed at specific concentrations (0.4, 0.6, and 0.8% by weight based on the total weight of resin and additive) with the copolyester having 31 mole % 1,4-cyclohexane dimethanol, 69 mole % ethylene glycol and 100 mole % terephthalic acid and compounded again using a Sterling 1.25 inch (3.18 cm) single screw extruder. This final compounded sample was then injection molded into 4 inch (10.16 cm)×4 (10.16 cm) inch plaques (0.125 inch (0.318 cm) thickness) using a 110 ton Toyo injection molding machine equipped with a 28 mm screw. Diffusion and Light Transmission measurements were then made on each plaque. Instrumented impact tests were also performed on these plaques according to ASTM D3763.

Additive screening: Acrylic, silicone, silica, PTFE, and core shell particles were obtained from various commercial sources. Some of the acrylic particles were crosslinked and others were not. Based on the comparison of visual observations to the measured optical properties, a diffusion of 150 degrees is considered optimum for the LED lighting application. The level of diffusion provided complete diffusion of the LED light source. Maximum light transmission is also a key goal for the material. A list of additives and results from analysis of plaques made from those compounded copolyester formulations are shown in the tables below.

The choice of additive composition is not only important to the optical properties of the final diffuser sheet, it is also important for the toughness (impact strength) of the sheet. The acrylic, silicone and core-shell particles that were evaluated as part of this work maintained the toughness of the material (as measured via instrumented impact) at smaller particle size (<10 microns). However, in contrast, silica-based particles, PTFE based particles, and large particle size acrylic additives significantly reduced the impact strength of the diffuser sheet, when added at concentrations required to achieve the necessary diffusion and light transmission. Therefore, the correct choice of additive composition is important to maintain the combination of durability and correct optical properties for a light diffusing copolyester composition and articles made therefrom.

A loss in physical properties can also develop when the material is processed multiple times, as is often the case when scrap material is added back to the process. In the case of the 5 micron acrylic bead additive, the durability of the sheet, such as instrumented impact strength, is maintained even after 4 passes through the extruder. FIG. 3 shows how the impact strength of the material changes with extrusion. Sheet was extruded and ground back into pellets. The reground pellets were then re-extruded and sheet was made again. This process was repeated 4 times. Each time, Instrumented impact strength was measured on the sheet samples. The sheet formulations made with the 5 micron acrylic bead maintained their toughness even after 4 passes though the extrusion/regrind process. In contrast, the energy at maximum load of sheet made with a commercial diffuser additive Ampacet™ 7000013-NP LIGHT DIFFUSER PET MB supplied by Ampacet was reduced after each successive pass through the extruder.

TABLE 6
Additive Data (particles added at 0.8% by weight)

| | | D₅₀ Average | % | |
|---|---|---|---|---|
| | | Particle Size | Light | Diffusion |
| Example | Diffusion Additive | (microns) | Transmission | Angle |
| 1 | Acrylic (Techpolymer ™ MBX-50) | 50 | 89 | 123 |
| 2 | Acrylic (Altuglass ™ BS100) | 30 | 90 | 134 |
| 3 | Acrylic (Techpolymer ™ MBX-30) | 30 | 89 | 134 |
| 4 | Acrylic (Kolon ™ MH-20FHD) | 20 | 88 | 136 |
| 5 | Acrylic (Techpolymer ™ MBX-20) | 20 | 89 | 138 |
| 6 | Acrylic (Techpolymer ™ MBX-12) | 12 | 89 | 142 |
| 7 | Acrylic (Kolon ™ MH-10FHD) | 10 | 88 | 143 |
| 8 | Acrylic (Techpolymer ™ MBX-8) | 8 | 85 | 149 |
| 9 | Acrylic (Kolon ™ MH-5FHD) | 5 | 83 | 153 |
| 10 | Core Shell (DOW Paraloid ™ | 5 | 67 | 161 |
| | EXL-5137; butadiene/styrene | | | |
| | core and MMA shell) | | | |
| 11 | Acrylic (Techpolymer ™MBX-5) | 5 | 81 | 155 |
| 12 | Acrylic (Techpolymer ™ MBX-5) | 5 | 81 | 155 |
| 13 | Silicone (Momentive TOSPEARL ™ 120) | 2 | 52 | 171 |

TABLE 7
Instrumented Impact Testing of Diffuser Compositions Containing
LED Diffuser Additives (added at 0.8% by weight)

| | | | | | Instru- | Instru- |
|---|---|---|---|---|---|---|
| | D₅₀ | | | | mented | mented |
| | Average | % | | | Impact | Impact |
| | Particle | Light | | | (% | (% |
| Diffusion | Size | Trans- | Diffusion | wt | Brittle) | Brittle) |
| Additive | (microns) | mission | Angle | % | 20° C. | −23° C. |
| Kolon ™ | 5 | 83 | 153 | 0.8 | 0 | 0 |
| MH-5FHD | | | | | | |
| Kolon ™ | 10 | 88 | 143 | 0.8 | 0 | 0 |
| MH-10FHD | | | | | | |
| Kolon ™ | 20 | 88 | 136 | 0.8 | 0 | 100 |
| MH-20FHD | | | | | | |
| Momentive | 2 | 52 | 171 | 0.8 | 0 | 20 |
| TOSPEARL ™ | | | | | | |
| 120 | | | | | | |
| Core Shell | 5 | 67 | 161 | 0.8 | 0 | 0 |
| (DOW | | | | | | |
| Paraloid ™ | | | | | | |
| EXL-5137; | | | | | | |
| butadiene/ | | | | | | |
| styrene core | | | | | | |
| and MMA | | | | | | |
| shell) | | | | | | |
| Altuglass ™ | 30 | 90 | 134 | 0.8 | 40 | 100 |
| BS100 | | | | | | |
| Micronized | 8 | 55 | 163 | 0.8 | 20 | 0 |
| PTFE | | | | | | |
| (Ceridust ™ | | | | | | |
| 9202F) | | | | | | |
| Techpolymer ™ | 5 | 81 | 155 | 0.8 | 0 | 20 |
| MBX-5 | | | | | | |
| Micronized | 4 | 57 | 175 | 3 | 40 | 100 |
| silica | | | | | | |
| (FujiSilya ™ | | | | | | |
| 350) | | | | | | |
| Spectar ™ | N/A | 91 | | | 0 | 0 |
| copolyester | | | | | | |
| 14471 | | | | | | |

TABLE 8

| | | | | II Max | | II Max | |
|---|---|---|---|---|---|---|---|
| | | | | Energy | Brittle | Energy | Brittle |
| | | | | @ | @ | @ | @ |
| | Sample | | Rework | 23 C. | 23 C. | −20 C. | −20 C. |
| Microbead | ID | Pass | (%) | (J) | (%) | (J) | (%) |
| Ampacet ™ | A-1 | 1 | 0 | 33 | 0 | 27 | 0 |
| | A-2 | 2 | 100 | 34 | 20 | 31 | 40 |
| | A-3 | 3 | 100 | 23 | 20 | 10 | 60 |
| | A-4 | 4 | 100 | 27 | 0 | 2 | 100 |
| Kolon ™ | K-1 | 1 | 0 | 31 | 0 | 34 | 0 |
| MH-5FD | K-2 | 2 | 100 | 35 | 0 | 35 | 0 |
| | K-3 | 3 | 100 | 35 | 0 | 35 | 0 |
| | K-4 | 4 | 100 | 33 | 0 | 34 | 0 |

This invention can be further illustrated by the following examples of preferred embodiments thereof, although it will be understood that these examples are included merely for purposes of illustration and are not intended to limit the scope of the invention unless otherwise specifically indicated.

In the drawings and specification, there have been disclosed typical preferred embodiments of the invention and, although specific terms are employed, they are used in a generic and descriptive sense only and not for purposes of limitation, the scope of the invention being set forth in the following claims.

1. A light diffusing article comprising:
a copolyester compositions comprising:
a) 90 to 99.5 weight percent copolyester, wherein the copolyester comprises one or more of polyethylene terephthalate (PET), glycol modified PET (PETG), glycol modified poly(cyclohexylene dimethylene terephthalate) (PCTG), poly(cyclohexylene dimethylene terephthalate) (PCT), acid modified poly(cyclohexylene dimethylene terephthalate) (PCTA), and any of the forgoing polymers modified with 2,2,4,4-tetramethylcyclobutane-1,3-diol, and
b) 0.5 to 10 weight percent of an acrylic light diffusion additive having an D₅₀ average particle size ranging from less than 10 microns to about 2 microns, wherein the acrylic additive comprises particles of a crosslinked acrylic polymer or a polymethyl methacrylate or a butadiene/styrene core with a methyl methacrylate (MMA) shell,
wherein the article has a light diffusion angle of from greater than 150 to about 170 degrees,
wherein the composition has a light transmission ranging from about 75 to about 95%, and a haze greater than 30%, measured according to ASTM D1003 on a plaque with a thickness of 3.175 mm (0.125 inch), and
wherein the weight percentages are based on the total weight of the copolyester.

2. The light diffusing article according to claim 1, wherein the acrylic light diffusion additive has an D₅₀ average particle size ranging from less than 10 microns to about 5 microns.

3. The light diffusing article according to claim 1, wherein the acrylic light diffusion additive has an D₅₀ average particle size ranging from about 2 microns to about 5 microns.

4. The light diffusing article according to claim 1, wherein the composition has a light diffusing angle 155 to 165 degrees.

5. The light diffusing article according to claim 1, wherein the copolyester composition comprises:
a) 99.5 to 99.4 weight percent of the copolyester, and
b) 0.5 to 0.6 weight percent of the acrylic light diffusion additive.

6. The light diffusing article according to claim 1, wherein the article has an energy at maximum load of at least 30 Joules at both 23° C. and −23° C., measured according to ASTM D3763 after three passes through an extruder.

7. The light diffusing article according to claim 1, wherein the acrylic additive comprises polymethyl methacrylate.

8. The light diffusing article according to claim 1, further comprising an inorganic light diffusing additive.

9. The light diffusing article according to claim 8, wherein the inorganic light diffusing additive comprises titanium dioxide, barium sulfate, calcium carbonate or mixtures thereof.

10. The light diffusing article according to claim 1, wherein the article is a film or sheet.

11. A method of making a light diffusing article, the method comprising:
(a) blending 90 to 99.5 weight percent copolyester, and 0.5 to 10 weight percent of an acrylic light diffusion additive having an D₅₀ average particle size ranging from less than 10 microns to about 0.5 microns to form a light diffusing composition, and
(b) forming the article by extrusion or injection molding,
wherein the copolyester comprises one or more of polyethylene terephthalate (PET), glycol modified PET (PETG), glycol modified poly(cyclohexylene dimethylene terephthalate) (PCTG), poly(cyclohexylene dimethylene terephthalate) (PCT), acid modified poly(cyclohexylene dimethylene terephthalate) (PCTA), and any of the forgoing polymers modified with 2,2,4,4-tetramethylcyclobutane-1,3-diol,
wherein the acrylic additive comprises particles of a crosslinked acrylic polymer or a polymethyl methacrylate or a butadiene/styrene core with a methyl methacrylate (MMA) shell,
wherein the article has a light diffusion angle of from greater than 150 to about 170 degrees,
wherein the article has a light transmission ranging from about 75 to about 95%, and a haze greater than 30%, measured according to ASTM D1003 on a plaque with a thickness of 3.175 mm (0.125 inch), and
wherein the weight percentages are based on the total weight of the copolyester and the additive.

12. The method according to claim 11, wherein the method further comprises subjecting the article to thermoforming, cold bending, hot bending, adhesive bonding, cutting, drilling, or laser cutting or a combination thereof.

13. A light diffusing composition comprising:
a) 90 to 99.5 weight percent copolyester, wherein the copolyester comprises one or more of glycol modified poly(cyclohexylene dimethylene terephthalate) (PCTG), poly(cyclohexylene dimethylene terephthalate) (PCT), acid modified poly(cyclohexylene dimethylene terephthalate) (PCTA), and any of the forgoing polymers or polyethylene terephthalate (PET), or glycol modified PET (PETG), modified with 2,2,4,4-tetramethylcyclobutane-1,3-diol, and
b) 0.5 to 10 weight percent of an acrylic light diffusion additive having an D₅₀ average particle size ranging from less than 10 microns to about 2 microns, wherein the acrylic additive comprises particles of a crosslinked acrylic polymer or a polymethyl methacrylate or a butadiene/styrene core with a methyl methacrylate (MMA) shell,
wherein the composition has a light diffusion angle of from greater than 150 to about 175 degrees,
wherein the composition has a light transmission ranging from about 75 to about 95%, and a haze greater than 30%, measured according to ASTM D1003 on a plaque with a thickness of 3.175 mm (0.125 inch), and
wherein the weight percentages are based on the total weight of the copolyester and the additive.

14. A light diffusing composition comprising:
a) 90 to 99.5 weight percent copolyester, wherein the copolyester comprises one or more of glycol modified poly(cyclohexylene dimethylene terephthalate) (PCTG), glycol modified poly(cyclohexylene dimethylene terephthalate) (PCTG), poly(cyclohexylene dimethylene terephthalate) (PCT), acid modified poly(cyclohexylene dimethylene terephthalate) (PCTA), and any of the forgoing polymers modified with 2,2,4,4-tetramethylcyclobutane-1,3-diol,
b) 0.5 to 10 weight percent of an acrylic light diffusion additive having an D₅₀ average particle size ranging from less than 10 microns to about 2 microns, wherein the acrylic additive comprises particles of a crosslinked acrylic polymer or a polymethyl methacrylate or a butadiene/styrene core with a methyl methacrylate (MMA) shell,
wherein the composition has a light diffusion angle of from greater than 150 to about 175 degrees,
wherein the composition has a light transmission ranging from about 75 to about 95%, and a haze greater than 30%, measured according to ASTM D1003 on a plaque with a thickness of 3.175 mm (0.125 inch), and
wherein the weight percentages are based on the total weight of the copolyester and the additive.

15. The light diffusing composition according to claim 13 or claim 14, wherein the acrylic light diffusion additive having an D₅₀ average particle size ranging from about 2 microns to less than about 5 microns.

16. The light diffusing composition according to claim 13 or claim 14, wherein the acrylic light diffusion additive having an D₅₀ average particle size ranging from about 2 microns to about 8 microns.

17. The light diffusing composition according to claim 13 or claim 14, wherein the acrylic light diffusion additive having an D₅₀ average particle size ranging from about 10 microns to less than about 5 microns.
